(19) United States
(12) Patent Application Publication
(10) Pub. No.: US 2026/0164303 A1
(43) Pub. Date: Jun. 11, 2026

(54) METHODS FOR DATA DROPPING FOR TIME-CRITICAL COMMUNICATION DURING HANDOVER

(71) Applicant: Telefonaktiebolaget LM Ericsson (publ), Stockholm (SE)

(72) Inventors: Zhenhua ZOU, Solna (SE); Torsten DUDDA, Wassenberg (DE); Nianshan SHI, Järfälla (SE)

(21) Appl. No.: 19/125,891

(22) PCT Filed: Oct. 31, 2023
(86) PCT No.: PCT/EP2023/080405

§ 371 Date: Apr. 30, 2025

Related U.S. Application Data
(60) Provisional application No. 63/421,402, filed on Nov. 1, 2022.

(51) Int. Cl. H04W 28/06; H04L 47/28; H04W 36/00; H04W 72/1263; H04W 76/20

(52) U.S. Cl. CPC H04W 28/06; H04L 47/28; H04W 36/0016; H04W 72/1263; H04W 76/20

(57) ABSTRACT

According to one aspect, a source network node configured to communicate with a wireless device (WD) and a target network node is described. The source network node is configured to obtain timing information associated with a Packet Data Convergence Protocol (PDCP) resource. The PDCP resource corresponds to a packet scheduled for downlink transmission from the source network node or uplink transmission from the WD. The source network node is further configured to transmit the timing information associated with the PDCP resource to the target network node for the target network node to determine, after a handover request has been transmitted by the source network node, whether to discard or cause the WD to discard the PDCP resource or the packet based on the timing information.

### TECHNICAL FIELD

The present disclosure relates to wireless communications, and in particular, to techniques for data dropping for time-critical communication during handover.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile wireless devices (WD), as well as communication between network nodes and between WDs. The 3GPP is also developing standards for Sixth Generation (6G) wireless communication networks.

### XR Service

eXtended Reality (XR) is an important 5G media application under consideration in the industry. XR is an umbrella term for different types of “realities” and generally may refer to any kind of real-and-virtual combined environment and human-machine interactions generated by computer technology and wearables. It includes representative forms such as Augmented Reality (AR), Mixed Reality (MR) and Virtual Reality (VR) and the areas interpolated among them.

FIG. 1 is a graphical depiction of the challenges in balancing various characteristics for XR in terms of reliability, latency constraint, and bitrate. Compared to Ultra-Reliable Low-Latency Communications (URLLC) type of services, with which the extreme requirement down to 1 ms latency and reliability to 10⁻⁵, edge-based XR often has relaxed latency requirement with minimum 5 ms up to a couple of 10 ms latency, a reliability requirement up to 10⁻⁴, however, much higher bite rate may be required for XR services, with larger file size 10 KB-100 KB, e.g., due to codec inefficiency.

Another traffic characteristic of XR is that it may be more dynamic due, e.g., to eye/viewport tracking. The traffic may appear to be periodic, but with file size varying, as depicted in the example timing diagram of FIG. 2, which depicts an example typical XR traffic profile.

When the application packet (which may be periodic but with a variable size) enters the internet, the initial packet may be transmitted into a single Protocol Data Unit (PDU) in the network or may be segmented several PDUs. This means that one application packet may, for instance, correspond to one or several Internet Protocol (IP) packets. IP packets arrive at the Radio Access Network (RAN) Packet Data Convergence Protocol (PDCP) layer, i.e. PDCP Service Data Units (SDUs), and the PDCP layer creates PDCP PDUs and delivers them to lower layers. For each SDU, the PDCP layer starts a PDCP discard timer at the reception of the SDU from upper layers. When this timer expires, the PDCP discards the PDCP SDU as well as the corresponding PDCP Data PDU. If the PDCP PDU was delivered to lower layers, PDCP indicates the discard to lower layers. Lower layers, e.g., RLC, will discard the PDCP PDUs (RLC SDU) if these RLC SDU or any segment of the RLC SDU has not yet been transmitted to lower layers.

XR Application PDUs may have time constraints. One or a set of application PDUs may need to reach the receiver within a certain period of time, i.e., with a limited latency. If the application PDU(s) is/are not received by this time, the application PDU(s) is/are not of any use and can be discarded. Another characteristic is that when one application PDU which should have been delivered within a certain latency bound are late, then the later application PDUs are no longer needed since the later application PDU will be dependent on the early application PDU for video decoding. The corresponding PDCP SDUs/PDUs should not then be transmitted either as it results in a waste of resources.

For example, in XR application service, there are several types of video frames. For instance, independent frames (I-frames) are frames which the decoder may decode without the assistance of other previously received frames. For B-frames or P-frames, on the other hand, decoding may depend on the successful reception of an independent frame and, possibly, of other dependent frames, i.e. B-frames or P-frames.

The existing independent discard timer between PDCP SDUs may not be appropriate to handle this unique situation of XR traffic, i.e., allowing longer stays of PDCP SDU in the buffer although they are may not be needed any more from an application perspective. Example reasons for this include the following:
An XR application may produce one or more application PDUs which must be delivered within a delay budget. The application or layers below the application may segment/concatenate these application PDUs.
PDCP receivers from upper layers IP PDUs (if IP is used); however, PDCP does not have any information about how these PDCP SDU (IP PDUs) map to the application PDUs which need to be delivered within the same latency budget.
The existing PDCP discard timer for single PDCP SDU may not be efficient enough to handle situations outlined in the above list items.

### URLLC and Survival Time

In the 5G Quality of Service (QoS) framework, a QoS flow is established in the 5G system and can be mapped to a Data Radio Bearer (DRB). The QoS flow is associated with QoS parameters, 5Q QoS Indicator (5QI), such as Packet Delay Budget (PDB). The 5G RAN scheduling packets of this QoS flow (mapped to a DRB in 5G RAN) may deliver packets within this PDB. Another metric discussed in the industrial automation communication context, related to PDB, is so called survival time. According to 3GPP TS 22.261 v18.4.0/TS 22.104 v18.2.0, for example, in some existing systems, survival time is defined as the time that an application consuming a communication service may continue without an anticipated message. The message is anticipated at the end of the PDB, and the survival time is the maximum additional time that a message is expected after PDB.

For Time Sensitive Communication (TSC) traffic types (typical in industrial automation communication) in existing systems, for example, 3GPP TS 23.501 v17.2.0 specifies TSC Assistance Information (TSCAI) signaling, with which further information on the QoS flow traffic can be provided from 5G core network to RAN. The knowledge of TSC traffic pattern is useful for 5G-AN (Access network) to allow it to more efficiently schedule periodic, deterministic traffic flows either via Configured Grants, Semi-Persistent Scheduling or with Dynamic Grants. A Survival Time may be provided either in terms of maximum number of messages (message is equivalent to a burst) or in terms of time units. Single burst may be expected within a single time period referred to as the periodicity, for example, as described in the below example table excerpted from 3GPP TS 23.501 v17.2.0:

TABLE 1
Example TSC Assistance Information (TSCAI)

| Assistance | |
|---|---|
| Information | Description |
| Flow | The direction of the TSC flow (uplink or downlink). |
| Direction | |
| Periodicity | It refers to the time period between start of two bursts. |
| Burst | The latest possible time when the first packet |
| Arrival | of the data burst arrives at either the |
| time | ingress of the RAN (downlink flow direction) or |
| (Optional) | egress interface of the UE (uplink flow direction). |
| Survival | Survival Time, as defined in TS 22.261, |
| Time | is synonymous with the time period an |
| (Optional) | application can survive without any burst. |

In some existing systems, once the survival time (ST) period starts (also called the survival time mode is entered), a RAN implementation may schedule the radio resource more robustly to ensure any subsequent messages can be delivered successfully before the survival time is violated. If the message is successfully delivered, the robust resource allocation may be replaced with a “normal” resource allocation. This is illustrated in the example timing diagram of FIG. 3, which depicts an example survival time configuration at the RAN. As shown in FIG. 3, at a first time, a “normal” allocation (i.e., a non-increased allocation) of PRBs is configured for a first message, up until the PDB is exhausted. The first message is determined to be lost, and the survival timer starts, at which time the network node/gNB allocates more resources for the second message. The second message arrives at a second time while the survival timer is still running, and more PRBs are allocated for the second message. The second message is delivered successfully prior to the expiration of the PDB and survival timer. A third message arrives at a third time, which uses a normal allocation of PRBs.

An increased resource allocation (i.e., a robust allocation which is greater than a “normal” allocation typically used) may only be needed if previous message(s) are not successfully delivered, whereas in all other cases, a normal resource allocation may be used. Note that the message failure rate is already a very rare event in some existing systems. For example, standard 5QI value of Delay Critical GBR QoS flows (from 82 to 86) in 3GPP TS 23.501 v17.2.0 has a packet error rate target of 10⁻⁴ or 10⁻⁵. The mechanism of survival time may be one way to ensure an even higher communication service availability target value (for example, 10⁻⁹).

Thus, a scheduling mechanism by the network which always allocates more radio resources for all data transmissions may not be spectrum efficient, since the survival time requirement (e.g., calculated as the probability that the communication service is not stopped, called communication service availability) may be very stringent, e.g., as low as 10⁻⁹. An opportunistic radio resource allocation may be more efficient to meet the communication service requirement while keeping the radio resource allocation within a reasonable amount.

Such a radio resource configuration, however, may not be configured to efficiently trigger the resource allocation shift. For periodic traffic, for example, a network node/gNB may be aware of the packet arrival at either wireless device or network node (e.g., by using TSCAI parameters), and then it can observe whenever a packet is not delivered within the packet delay budget. Upon observing this, a network node may schedule the subsequent packet with higher reliability to help ensure the survival time is not violated, such as, e.g., sending a (re)-activation command for uplink (UL) CG or a dynamic uplink grant with a more robust Modulation Coding scheme (MCS), or even activating PDCP duplication.

In existing systems, during handover of the wireless device from the source Next-Generation RAN (NG-RAN) to the target NG-RAN, the user plane data transmission is typically interrupted. If one UL packet is still under transmission (e.g., waiting for Hybrid Automatic Repeat Request (HARQ) retransmission or even Radio Link Control (RLC) retransmission) during the handover, then this packet would be re-transmitted in the target cell and might not meet the packet delay budget. For example, the handover interruption time in practice may be between 43 and 160 milliseconds (ms) in different cases. If the handover is via the core network, the handover interruption time would be even longer. Even though Dual Active Protocol Stack (DAPS) has been specified in the 3GPP Rel-16 to support zero millisecond interruption, it only calculates the interruption time from the connection point of view, but not from individual packet point of view. DAPS handover is a handover procedure that maintains the source network node/gNB connection after reception of Radio Resource Control (RRC) message for handover and until releasing the source cell after successful random access to the target network node/gNB. There are some further restrictions for DAPS, such as it does not apply for FR2-to-FR2 handover.

For time critical communication including, e.g., XR services and industrial automation with survival time, one noticeable difference from mobile broadband service is that there is a deadline associated with packets. If the delivery of these packets has already exceeded their deadlines, then it is beneficial to drop those packets so that the radio resources are not wasted in not-useful transmissions (e.g., that subsequent packets having also a deadline are not delayed due to these not-useful transmissions).

Since the handover interruption time can be large and varying, after the handover, the wireless device and/or network node may still transmit the data that is of no use. This can happen under the below cases:
1. The packet has passed its deadlines;
2. The packet cannot meet its deadline due to additional data transmission scheduling delay in the target, assuming that the packet has stayed in the source for some time; and/or
3. If there is a survival time associated with the service, it may pay-off to deliberately discard the preceding packets, which may stay in the buffer for a while and have shorter time to its deadline than a new arrival packet. The target NG-RAN then can allocate all resources for the subsequent packets.

Handover procedures should ideally try to avoid data loss. Existing systems, however, are not configured for properly discarding the delayed (and not useful) packets (including PDCP SDU, RLC SDU, RLC PDU) during handover. One existing solution is to configure PDCP discard timer at the wireless device (which is kept running during handover), but this may be usable for the above Case 1 when the packet has passed its deadlines, not for the DL traffic during handover (in the case when there is a change of PDCP anchoring point at the network side). Also, the existing solution cannot address the XR service which has inter-dependencies between consecutive application PDUs.

Thus, existing systems lack mechanisms for data dropping for time-critical communication during handover.

### SUMMARY

Some embodiments advantageously provide methods, systems, and apparatuses for data dropping for time-critical communication during handover.

In some embodiments, the WD and the target network node discard the PDCP SDUs and PDUs that are of no use anymore (e.g., missing their latency deadline).

In some embodiments, for the downlink (DL) traffic, the source network node is configured to forward timing information, such as timestamp of when PDCP SDU became available for transmission (e.g., implementation specific discard/Active Queue Management (AQM) timer starting time, or expiry time) for forwarded PDCP SDUs and/or PDUs, to the target network node of a handover. After the handover interruption time, the target network node determines, based on this forwarded timing information/timestamp, whether the PDCP SDU and/or PDU may be discarded instead of transmitted/retransmitted, and in some embodiments, discarding it if the deadline has passed. When the data PDUs are associated, e.g., by ADUs, the source RAN may compute and/or send the reference time, so that the target RAN understands without the acknowledgement of the reception of the “important” data PDU (e.g., I-frames), the remaining data PDUs can be discarded.

In some embodiments, for UL traffic, a network node indicates to the WD to discard PDCP SDUs and/or PDCP PDUs, which are not to be transmitted to the target network node. This includes discarding of potential PDCP PDU retransmissions in PDCP after the handover interruption. In some embodiments, a PDCP SN gap may not be introduced with this discarding, i.e., PDCP PDUs following this discard may have subsequent sequence numbers to the PDCP PDU before this discard.

Thus, in some embodiments, only useful PDCP SDU/PDUs may be transmitted after the handover, so that the target network node can schedule radio resources more efficiently and those SDUs/PDUs can achieve a low latency and a high reliability compared to existing solutions. In other words, non-useful PDCP SDU/PDUs are not transmitted, and the network node can transmit the follow-up SDUs that are of importance to the upper layer applications.

According to one aspect, a source network node configured to communicate with a wireless device (WD) and a target network node is described. The source network node is configured to obtain timing information associated with a Packet Data Convergence Protocol (PDCP) resource. The PDCP resource corresponds to a packet scheduled for downlink transmission from the source network node or uplink transmission from the WD. The source network node is further configured to transmit the timing information associated with the PDCP resource to the target network node for the target network node to determine, after a handover request has been transmitted by the source network node, whether to discard or cause the WD to discard the PDCP resource or the packet based on the timing information.

In some embodiments, the timing information associated with the PDCP resource includes one or more of: (A) when the PDCP resource became available for transmission at the source network node; (B) when a discard timer for the PDCP resource times out; (C) when an active queue management (AQM) process triggers a drop for the PDCP resource; (D) when the source network node expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some embodiments, the source network node is further configured to determine whether to perform a handover of the WD from the source network node to the target network node based on a measurement report.

In some other embodiments, the source network node is further configured to transmit the handover request to the target network node or the WD.

In some embodiments, the source network node is further configured to transmit the PDCP resource to the target network node.

In some other embodiments, the timing information is included in the handover request.

In some embodiments, the source network node is further configured to determine that a timing condition cannot be met if the source network node or the WD transmits the PDCP resource or the packet. The timing condition is associated with the timing information.

In some other embodiments, the source network node is further configured to transmit at least the timing information in response to the determination that the timing condition cannot be met.

In some embodiments, the PDCP resource is one or both of a PDCP PDU and a PDCP service data unit (SDU).

In some other embodiments, the packet comprises DL data or UL data.

According to another aspect, a method in a source network node configured to communicate with a wireless device (WD) and a target network node is described. The method includes obtaining timing information associated with a Packet Data Convergence Protocol (PDCP) resource. The PDCP resource corresponds to a packet scheduled for downlink transmission from the source network node or uplink transmission from the WD. The method also includes transmitting the timing information associated with the PDCP resource to the target network node for the target network node to determine, after a handover request has been transmitted by the source network node, whether to discard or cause the WD to discard the PDCP resource or the packet based on the timing information.

In some embodiments, the timing information associated with the PDCP resource includes one or more of: (A) when the PDCP resource became available for transmission at the source network node; (B) when a discard timer for the PDCP resource times out; (C) when an active queue management (AQM) process triggers a drop for the PDCP resource; (D) when the source network node expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some other embodiments, the method further includes determining whether to perform a handover of the WD from the source network node to the target network node based on a measurement report.

In some embodiments, the method further includes transmitting the handover request to the target network node or the WD.

In some other embodiments, the method further includes transmitting the PDCP resource to the target network node.

In some embodiments, the timing information is included in the handover request.

In some other embodiments, the method further includes determining that a timing condition cannot be met if the source network node or the WD transmits the PDCP resource or the packet. The timing condition is associated with the timing information.

In some embodiments, the method further includes transmitting at least the timing information in response to the determination that the timing condition cannot be met.

In some other embodiments, the PDCP resource is one or both of a PDCP PDU and a PDCP service data unit, SDU.

In some embodiments, the packet comprises DL data or UL data.

According to one aspect, a target network node configured to communicate with a wireless device (WD) and a source network node is described. The target network node is configured to receive, from the source network node, timing information associated with a Packet Data Convergence Protocol (PDCP) resource. The PDCP resource corresponds to a packet scheduled for downlink transmission from the source network node or uplink transmission from the WD. The target network node is further configured to determine, after a handover request has been transmitted by the source network node, whether to discard or cause the WD to discard the PDCP resource or the packet based on the timing information, and one of discard or cause the WD to discard the PDCP resource or the packet based on the determination.

In some embodiments, the timing information associated with the PDCP resource includes one or more of: (A) when the PDCP resource became available for transmission at the source network node; (B) when a discard timer for the PDCP resource times out; (C) when an active queue management (AQM) process triggers a drop for the PDCP resource; (D) when the source network node expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some other embodiments, the target network node is further configured to one of transmit or cause the WD to transmit the PDCP resource or the packet based on the determination.

In some embodiments, the target network node is further configured to receive the handover request from the source network node.

In some other embodiments, the timing information is included in the handover request.

In some embodiments, the target network node is further configured to determine that a timing condition cannot be met if the target network node or the WD transmits the PDCP resource or the packet. The timing condition is associated with the timing information.

In some other embodiments, the target network node is further configured to determine whether to discard or cause the WD to discard the PDCP resource or the packet further based on the determination that the timing condition cannot be met.

In some embodiments, causing the WD to discard includes transmitting an indication to the WD to discard the PDCP resource or the packet.

In some other embodiments, the PDCP resource is one or both of a PDCP PDU and a PDCP service data unit (SDU).

In some embodiments, the packet comprises DL data or UL data.

According to another aspect, a method in a target network node configured to communicate with a wireless device (WD) and a source network node is described. The method includes receiving, from the source network node, timing information associated with a Packet Data Convergence Protocol (PDCP) resource. The PDCP resource corresponds to a packet scheduled for downlink transmission from the source network node or uplink transmission from the WD. The method further includes determining, after a handover request has been transmitted by the source network node, whether to discard or cause the WD to discard the PDCP resource or the packet based on the timing information and one of discarding or causing the WD to discard the PDCP resource or the packet based on the determination.

In some embodiments, the timing information associated with the PDCP resource includes one or more of: (A) when the PDCP resource became available for transmission at the source network node; (B) when a discard timer for the PDCP resource times out; (C) when an active queue management (AQM) process triggers a drop for the PDCP resource; (D) when the source network node expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some other embodiments, the method further includes one of transmitting or causing the WD to transmit the PDCP resource or the packet based on the determination.

In some embodiments, the method further includes receiving the handover request from the source network node.

In some other embodiments, the timing information is included in the handover request.

In some embodiments, the method further includes determining that a timing condition cannot be met if the target network node or the WD transmits the PDCP resource or the packet. The timing condition is associated with the timing information.

In some other embodiments, the method further includes determining whether to discard or cause the WD to discard the PDCP resource or the packet further based on the determination that the timing condition cannot be met.

In some embodiments, causing the WD to discard includes transmitting an indication to the WD to discard the PDCP resource or the packet.

In some other embodiments, the PDCP resource is one or both of a PDCP PDU and a PDCP service data unit (SDU).

In some embodiments, the packet comprises DL data or UL data.

According to one aspect, a wireless device (WD) configured to communicate with a source network node and a target network node is described. The WD is configured to perform a handover of the WD from the source network node to the target network node. The target network node has received, from the source network node, timing information associated with a Packet Data Convergence Protocol (PDCP) resource. The PDCP resource corresponds to a packet scheduled for downlink transmission from the source network node or uplink transmission from the WD. The WD is further configured to receive, from the target network node, an indication to discard the PDCP resource or the packet, where the indication is transmitted based on the timing information, and discard the PDCP resource or the packet based on the indication.

In some embodiments, the indication includes a sequence number (SN), and the WD is further configured to discard the PDCP resource or the packet based on the SN.

In some other embodiments, discarding the PDCP resource based on the SN includes discarding other PDCP resources up to the SN.

In some embodiments, the WD is further configured to stop preprocessing of PDCP resources during the handover based on the indication.

In some other embodiments, the WD is further configured to transmit a first message indicating that a Radio Resource Control (RRC) configuration is complete and in response to the first message, receive, from the target network node, a second message.

The second message is an RRC message and includes the indication.

In some embodiments, the PDCP resource is one or both of a PDCP PDU and a PDCP service data unit (SDU).

In some other embodiments, the packet comprises DL data or UL data.

According to another aspect, a method in a wireless device (WD) configured to communicate with a source network node and a target network node is described. The method includes performing a handover of the WD from the source network node to the target network node. The target network node has received, from the source network node, timing information associated with a Packet Data Convergence Protocol (PDCP) resource. The PDCP resource corresponds to a packet scheduled for downlink transmission from the source network node or uplink transmission from the WD. The method also includes receiving, from the target network node, an indication to discard the PDCP resource or the packet, where the indication is transmitted based on the timing information, and discarding the PDCP resource or the packet based on the indication.

In some embodiments, the indication includes a sequence number (SN), and the method further includes discarding the PDCP resource or the packet based on the SN.

In some other embodiments, discarding the PDCP resource based on the SN includes discarding other PDCP resources up to the SN.

In some embodiments, the method further includes stopping preprocessing of PDCP resources during the handover based on the indication.

In some other embodiments, the method further includes transmitting a first message indicating that a Radio Resource Control (RRC) configuration is complete and in response to the first message, receiving, from the target network node, a second message. The second message is an RRC message and includes the indication.

In some embodiments, the PDCP resource is one or both of a PDCP PDU and a PDCP service data unit (SDU).

In some other embodiments, the packet comprises DL data or UL data.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a graphical depiction of the challenges in balancing various characteristics for XR in terms of reliability, latency constraint, and bitrate;

FIG. 2 is a timing diagram which depicts an example typical XR traffic profile;

FIG. 3 is a timing diagram which depicts an example survival time configuration at the RAN;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating exemplary methods implemented in a communication system including a host computer, a network node and a wireless device for executing a client application at a wireless device according to some embodiments of the present disclosure;

FIG. 7 is a flowchart illustrating exemplary methods implemented in a communication system including a host computer, a network node and a wireless device for receiving user data at a wireless device according to some embodiments of the present disclosure;

FIG. 8 is a flowchart illustrating exemplary methods implemented in a communication system including a host computer, a network node and a wireless device for receiving user data from the wireless device at a host computer according to some embodiments of the present disclosure;

FIG. 9 is a flowchart illustrating exemplary methods implemented in a communication system including a host computer, a network node and a wireless device for receiving user data at a host computer according to some embodiments of the present disclosure;

FIG. 10 is a flowchart of an exemplary process in a network node for data dropping for time-critical communication during handover according to some embodiments of the present disclosure;

FIG. 11 is a flowchart of an exemplary process in a wireless device for data dropping for time-critical communication during handover according to some embodiments of the present disclosure;

FIG. 12 is a flowchart of another exemplary process in a network node for data dropping for time-critical communication during handover according to some embodiments of the present disclosure;

FIG. 13 is a flowchart of another exemplary process in another network node for data dropping for time-critical communication during handover according to some embodiments of the present disclosure;

FIG. 14 is a flowchart of an exemplary process in a wireless device for data dropping for time-critical communication during handover according to some embodiments of the present disclosure;

FIG. 15 shows an example flow chart and signaling diagram for DL data discard in some embodiments of the present disclosure; and

FIG. 16 shows a flow chart and signaling diagram for UL data discard according to some embodiments of the present disclosure.

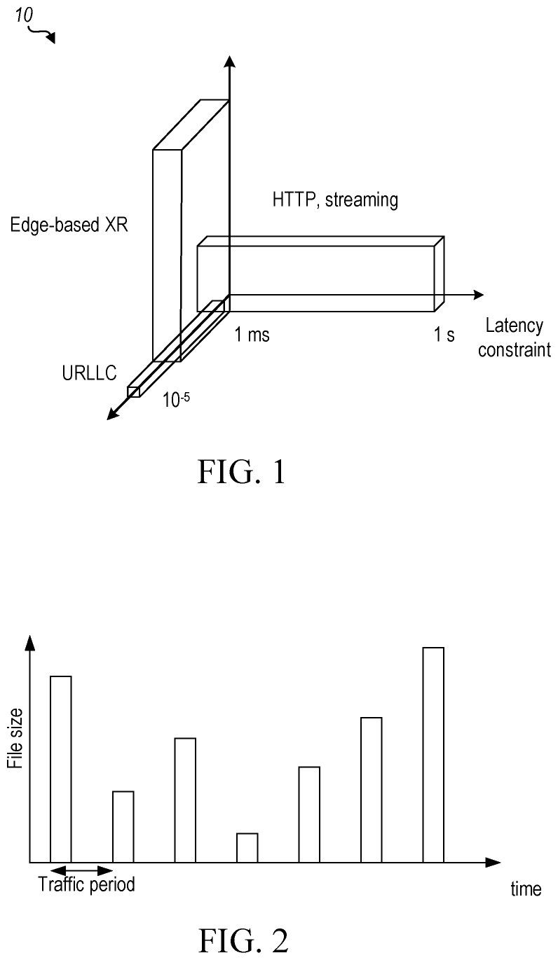

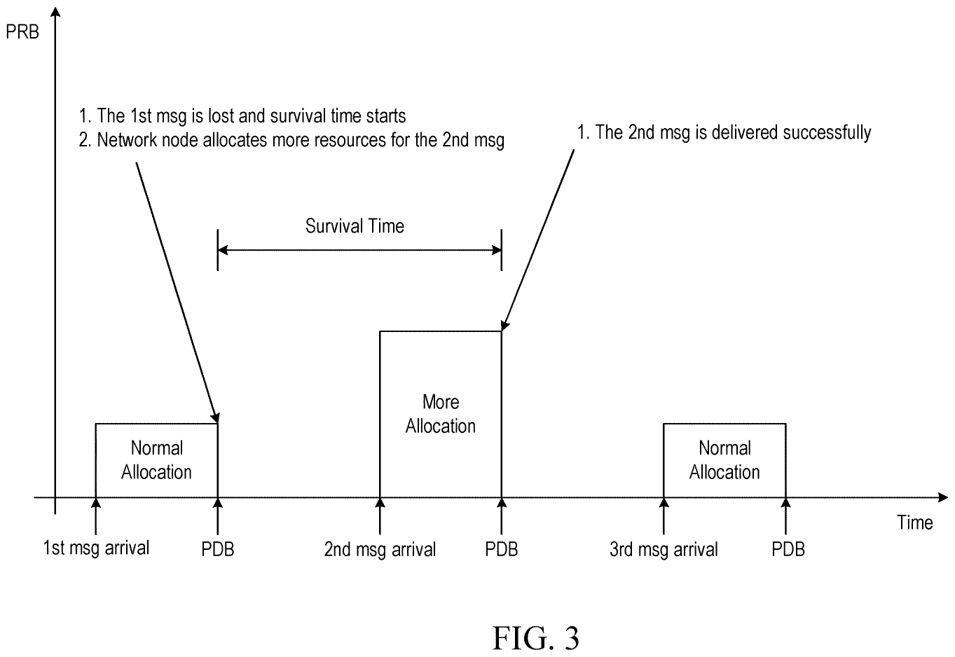

### DETAILED DESCRIPTION

Before describing in detail exemplary embodiments, it is noted that the embodiments reside primarily in combinations of apparatus components and processing steps related to data dropping for time-critical communication during handover. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), JAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the term PDCP resource is used and may refer to any resource associated with PDCP such as a PDU, an SDU, data, a portion of a packet, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide techniques for data dropping for time-critical communication during handover.

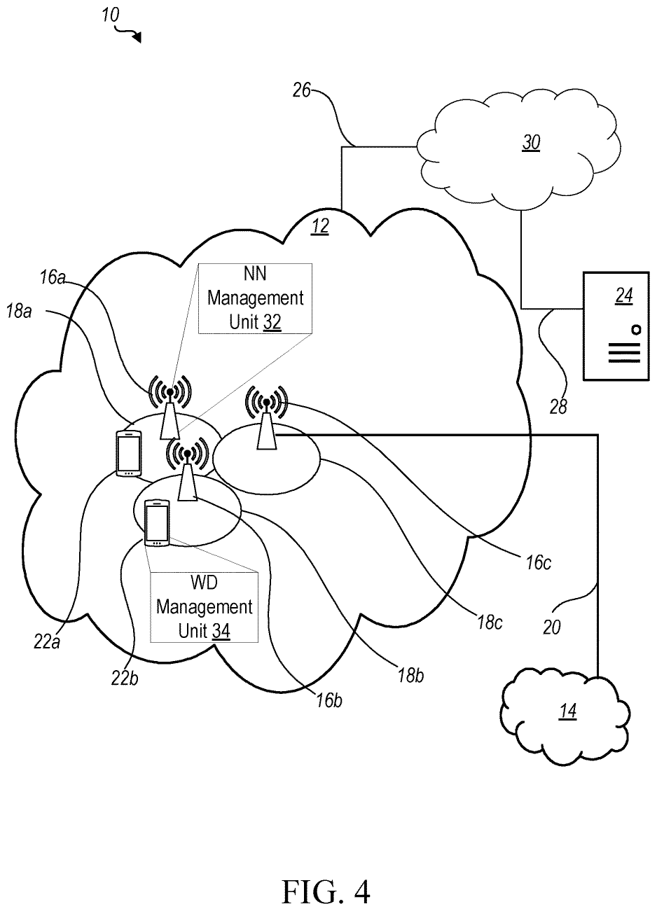

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

The cell currently being used by WD 22 may be referred to as a source cell (e.g., served by a source network node 16a) while the cell to which WD 22 is to be handed over (e.g., as a result of a handoff/handover procedure) may be referred to as a target cell (served by a target network node 16b). While it may be that both the source cell and the target cell are provided by the same network node 16, for purposes of simplicity herein, it may be assumed that the source cell is associated with a source network node 16a and the target cell is associated with a (different) target network node 16b.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured data dropping for time-critical communication during handover. A wireless device 22 is configured to include a WD management unit 34 which is configured data dropping for time-critical communication during handover.

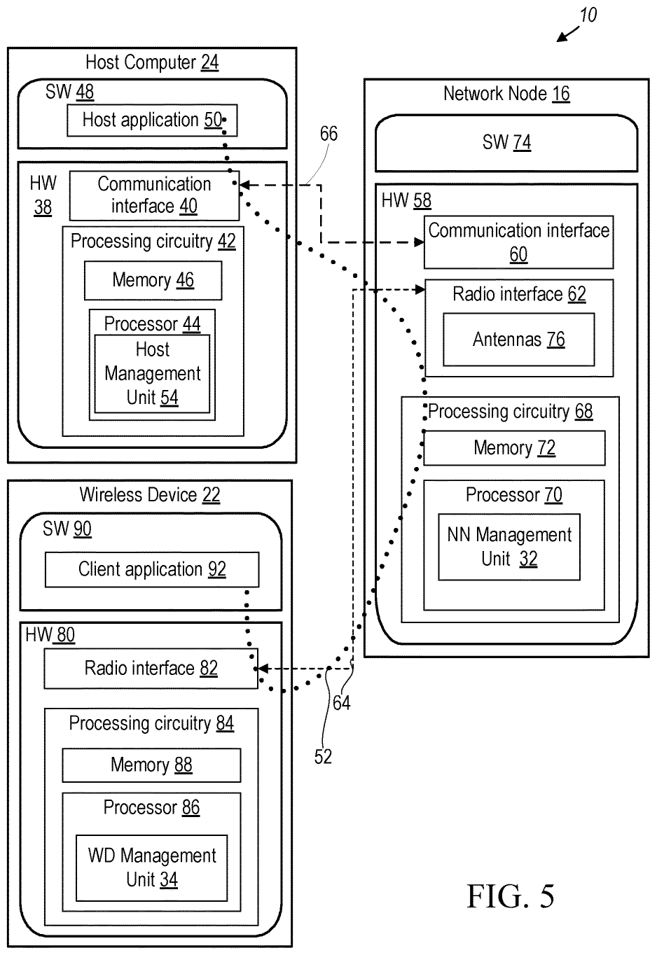

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 configured for data dropping for time-critical communication during handover.

In some embodiments, the hardware and/or software of source network node 16a and target network node 16b are similar, and thus, the network node 16 depicted in FIG. 5 may refer to either of source network node 16a and target network node 16b.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 configured for data dropping for time-critical communication during handover.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as NN management unit 32, and a WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

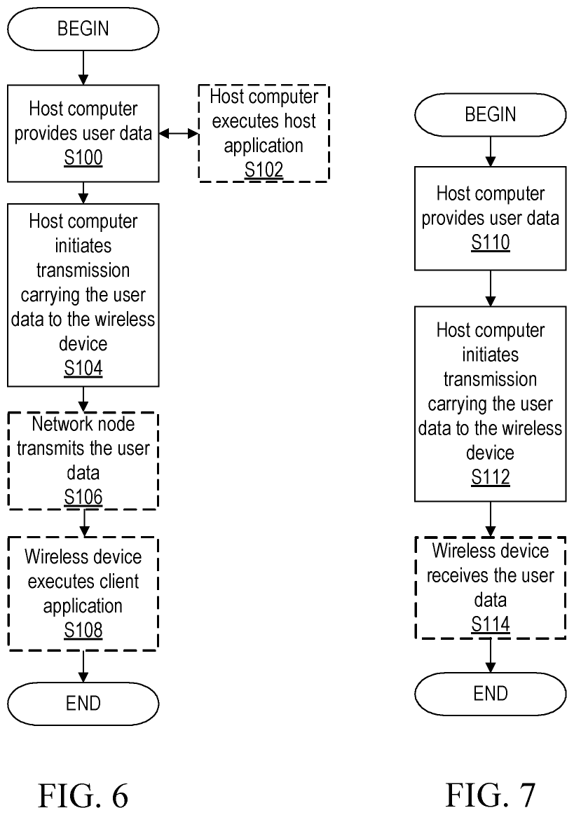

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

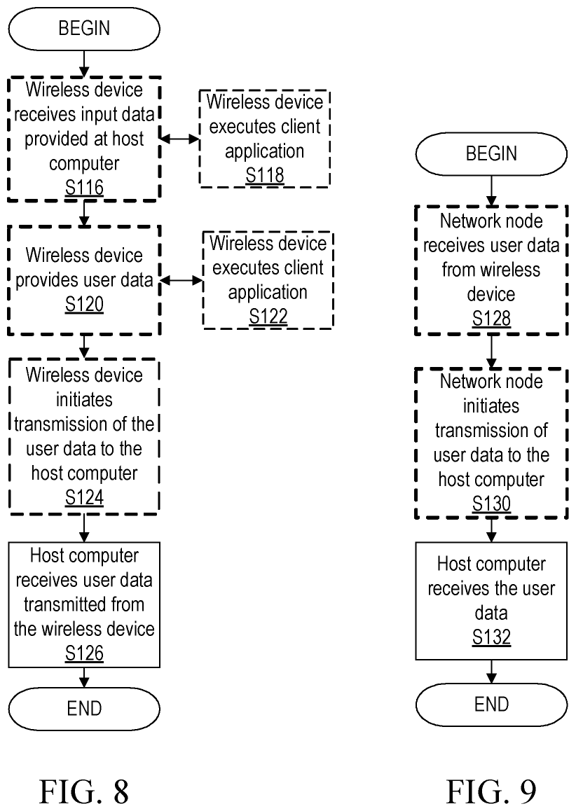

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

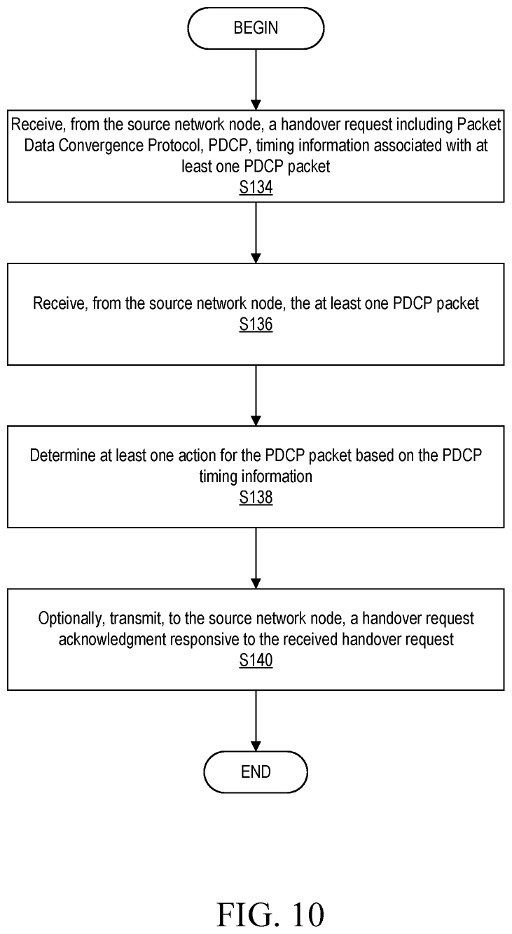

FIG. 10 is a flowchart of an exemplary process in a network node 16 (e.g., a target network node 16b) for data dropping for time-critical communication during handover. One or more blocks described herein may be performed by one or more elements of network node 16 such as by one or more of processing circuitry 68 (including the NN management unit 32), processor 70, radio interface 62 and/or communication interface 60. Target network node 16b is configured to receive (Block S134), from the source network node 16a, a handover request including Packet Data Convergence Protocol, PDCP, timing information associated with at least one PDCP packet. Target network node 16b is configured to receive (Block S136), from the source network node 16a, the at least one PDCP packet. Target network node 16b is configured to determine (Block S138) at least one action for the PDCP packet based on the PDCP timing information. Target network node 16b is configured, optionally, to transmit (Block S140), to the source network node 16a, a handover request acknowledgment responsive to the received handover request.

In one or more embodiments, the PDCP timing information includes at least one of a first time at which the PDCP packet became available for transmission in the source network node 16a, a second time at which a discard timer for the PDCP packet expires, and/or a third time at which an Active Queue Management (AQM) mechanism triggers a drop for the PDCP packet.

In one or more embodiments, the at least one action for the PDCP packet includes forwarding the PDCP packet to the wireless device or discarding the PDCP packet.

In one or more embodiments, the discarding of the PDCP packet is based on the discard timer for the PDCP packet expiring.

In one or more embodiments, the discarding of the PDCP packet includes determining an importance metric associated with the PDCP packet and discarding at least one additional PDCP packet based on the importance metric exceeding a threshold.

In one or more embodiments, the determining at least one action for the PDCP packet is further based on at least one of a fourth time at which the target network node 16b is expected to begin transmitting the PDCP packet, and a fifth time at which the target network node is expected to finish transmitting the PDCP packet.

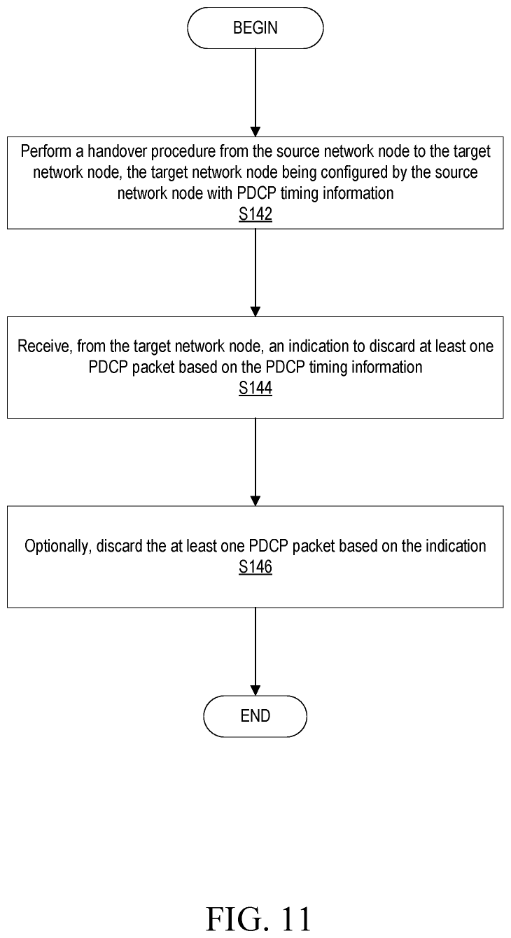

FIG. 11 is a flowchart of an exemplary process in a wireless device 22 according to some embodiments of the present disclosure for data dropping for time-critical communication during handover. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to perform (Block S142) a handover procedure from the source network node 16a to the target network node 16b, the target network node 16b being configured by the source network node 16a with PDCP timing information. Wireless device 22 is configured to receive (Block S144), from the target network node 16b, an indication to discard at least one PDCP packet based on the PDCP timing information. Wireless device 22 is configured to, optionally, drop (Block S146) the at least one PDCP packet based on the indication.

In one or more embodiments, the indication to discard the at least one PDCP packet includes an indicated sequence number, SN. The discarding of the at least one PDCP packet includes discarding a first PDCP packet, and discarding at least one subsequent PDCP packet based on the indicated SN being greater than or equal to a subsequent SN of the at least one subsequent PDCP packet.

In one or more embodiments, the WD 22 is further configured to assign a new SN to at least one non-dropped PDCP packet following the at least one subsequent PDCP packet, where the new SN is consecutive with a previous SN of a previous PDCP packet which was received prior to the first PDCP packet.

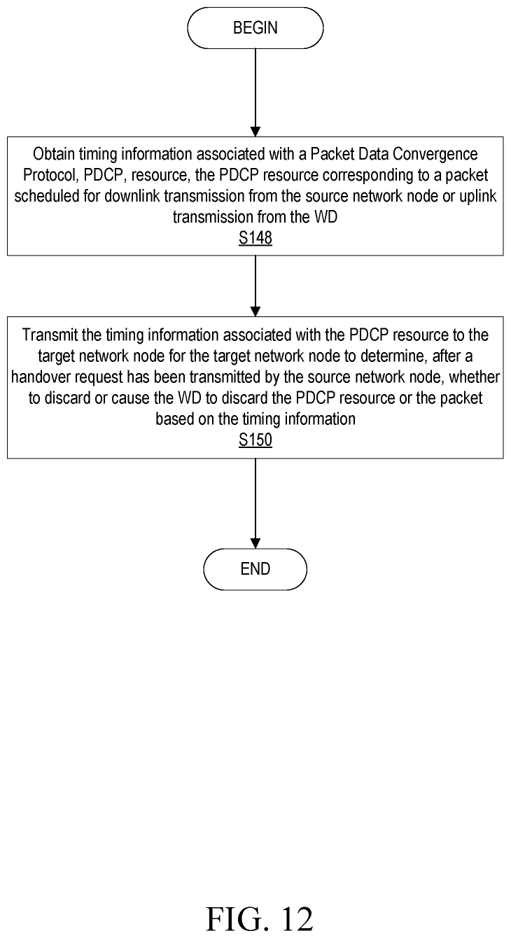

FIG. 12 is a flowchart of an exemplary process in a network node 16 (e.g., a source network node 16a). One or more blocks described herein may be performed by one or more elements of network node 16 such as by one or more of processing circuitry 68 (including the NN management unit 32), processor 70, radio interface 62 and/or communication interface 60. Source network node 16a is configured to obtain (Block S148) timing information associated with a Packet Data Convergence Protocol (PDCP) resource. The PDCP resource corresponds to a packet scheduled for downlink transmission from the source network node 16a or uplink transmission from the WD 22. The source network node 16a is further configured to transmit (Block S150) the timing information associated with the PDCP resource to the target network node 16b for the target network node 16b to determine, after a handover request has been transmitted by the source network node 16a, whether to discard or cause the WD 22 to discard the PDCP resource or the packet based on the timing information.

In some embodiments, the timing information associated with the PDCP resource includes one or more of: (A) when the PDCP resource became available for transmission at the source network node 16a; (B) when a discard timer for the PDCP resource times out; (C) when an active queue management (AQM) process triggers a drop for the PDCP resource; (D) when the source network node 16a expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some other embodiments, the method further includes determining whether to perform a handover of the WD 22 from the source network node 16a to the target network node 16b based on a measurement report.

In some embodiments, the method further includes transmitting the handover request to the target network node 16b or the WD 22.

In some other embodiments, the method further includes transmitting the PDCP resource to the target network node 16b.

In some embodiments, the timing information is included in the handover request.

In some other embodiments, the method further includes determining that a timing condition cannot be met if the source network node 16a or the WD 22 transmits the PDCP resource or the packet. The timing condition is associated with the timing information.

In some embodiments, the method further includes transmitting at least the timing information in response to the determination that the timing condition cannot be met.

In some other embodiments, the PDCP resource is one or both of a PDCP PDU and a PDCP service data unit, SDU.

In some embodiments, the packet comprises DL data or UL data.

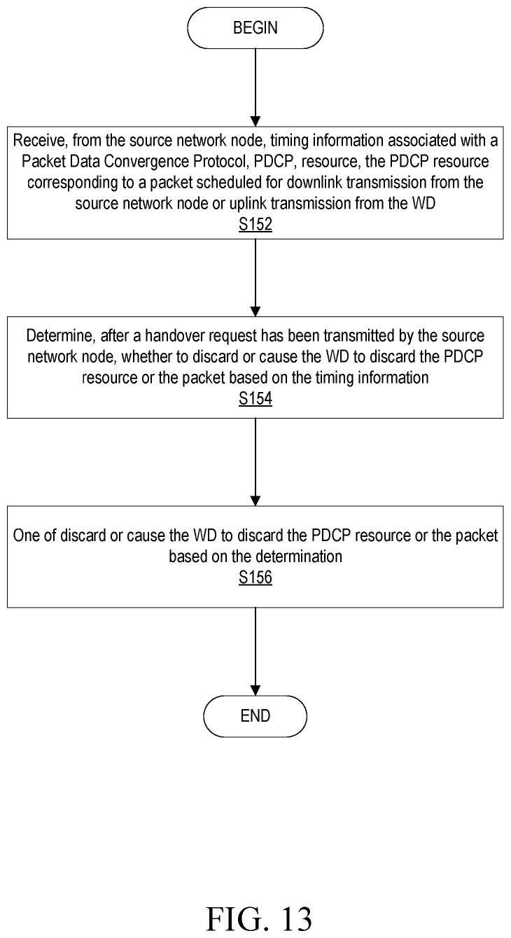

FIG. 13 is a flowchart of an exemplary process in a network node 16 (e.g., a target network node 16b). One or more blocks described herein may be performed by one or more elements of network node 16 such as by one or more of processing circuitry 68 (including the NN management unit 32), processor 70, radio interface 62 and/or communication interface 60. Target network node 16b is configured to receive (Block S152), from the source network node 16a, timing information associated with a Packet Data Convergence Protocol (PDCP) resource. The PDCP resource corresponds to a packet scheduled for downlink transmission from the source network node 16a or uplink transmission from the WD 22. The target network node 16b is further configured to determine (Block S154), after a handover request has been transmitted by the source network node 16a, whether to discard or cause the WD 22 to discard the PDCP resource or the packet based on the timing information, and one of discard or cause the WD 22 to discard the PDCP resource or the packet based on the determination (Block S156).

In some embodiments, the timing information associated with the PDCP resource includes one or more of: (A) when the PDCP resource became available for transmission at the source network node 16a; (B) when a discard timer for the PDCP resource times out; (C) when an active queue management (AQM) process triggers a drop for the PDCP resource; (D) when the source network node 16a expects a subsequent uplink PDCCP resource; (E) PDCP protocol data unit, PDU, time information in data forwarding and offloading information associated with an information element within the handover request; (F) a PDCP PDU time stamp; (G) a PDCP discard timer; and (H) the PDCP PDU time information included in a reporting list.

In some other embodiments, the method further includes one of transmitting or causing the WD 22 to transmit the PDCP resource or the packet based on the determination.

In some embodiments, the method further includes receiving the handover request from the source network node 16a.

In some other embodiments, the timing information is included in the handover request.

In some embodiments, the method further includes determining that a timing condition cannot be met if the target network node 16b or the WD 22 transmits the PDCP resource or the packet. The timing condition is associated with the timing information.

In some other embodiments, the method further includes determining whether to discard or cause the WD 22 to discard the PDCP resource or the packet further based on the determination that the timing condition cannot be met.

In some embodiments, causing the WD 22 to discard includes transmitting an indication to the WD 22 to discard the PDCP resource or the packet.

In some other embodiments, the PDCP resource is one or both of a PDCP PDU and a PDCP service data unit (SDU).

In some embodiments, the packet comprises DL data or UL data.

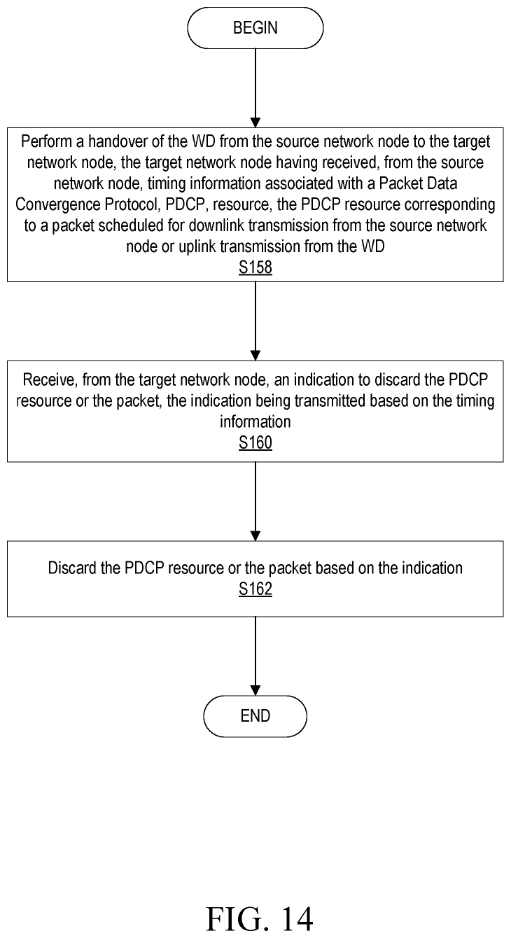

FIG. 14 is a flowchart of an exemplary process in a wireless device 22 according to some embodiments of the present disclosure for data dropping for time-critical communication during handover. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to perform (Block S158) a handover of the WD 22 from the source network node 16a to the target network node 16b. The target network node 16b has received, from the source network node 16a, timing information associated with a Packet Data Convergence Protocol (PDCP) resource. The PDCP resource corresponds to a packet scheduled for downlink transmission from the source network node 16a or uplink transmission from the WD 22. The WD 22 is further configured to receive (Block S160), from the target network node 16b, an indication to discard the PDCP resource or the packet, where the indication is transmitted based on the timing information, and discard (Block S162) the PDCP resource or the packet based on the indication.

In some embodiments, the indication includes a sequence number (SN), and the method further includes discarding the PDCP resource or the packet based on the SN.

In some other embodiments, discarding the PDCP resource based on the SN includes discarding other PDCP resources up to the SN.

In some embodiments, the method further includes stopping preprocessing of PDCP resources during the handover based on the indication.

In some other embodiments, the method further includes transmitting a first message indicating that a Radio Resource Control (RRC) configuration is complete and in response to the first message, receiving, from the target network node 16b, a second message. The second message is an RRC message and includes the indication.

In some embodiments, the PDCP resource is one or both of a PDCP PDU and a PDCP service data unit (SDU).

In some other embodiments, the packet comprises DL data or UL data.

Having described the general process flow of arrangements of the disclosure and having provided examples of hardware and software arrangements for implementing the processes and functions of the disclosure, the sections below provide details and examples of arrangements for data dropping for time-critical communication during handover.

### Downlink Data Discard

In the downlink, timing related information for discarding of PDCP SDUs needs to be evaluated both in source NG-RAN node and target NG-RAN node. In one embodiment of the present disclosure, for example, the source network node 16a “memorizes” (i.e., stores/records in memory 72) timing related information for a PDCP SDU, e.g., when the PDCP SDU became available for transmission in the source NG-RAN network, when a discard timer for the PDCP SDU would time out, when AQM mechanism would trigger a drop for this PDCP SDU, etc. The source network node 16a may forward this information (e.g. timestamp) alongside with the PDCP SDUs to the target network node 16b, i.e., when PDCP SDUs are undergoing forwarding procedure during handover between the network nodes 16a and 16b, or when PDCP SDU is forwarded to be retransmitted in the target network node 16b.

It may be assumed in some embodiments that source network node 16a and target network node 16b maintain a common reference time, e.g., GNSS or GPS time, and/or that they are synchronized to a local clock. This common reference time may be used as a reference for the timestamping.

The target network node 16b may utilize this timing information when evaluating to discard a PDCP SDU instead of (re)-transmitting a PDCP SDU.

In one or more embodiments, for example, the target NG-RAN node (network node 16b) does not pre-process the PDCP PDU out of the PDCP SDU until the handover interruption time has passed, and then evaluates whether the PDCP SDU should be discarded based on the time passed instead of transmitted or retransmitted. This may also avoid discarding a specific PDCP PDU already created based on the SDU creating a gap in the SN sequence. This can additionally avoid any RLC PDUs out of this PDCP PDUs being submitted to lower layers for transmission (e.g., due to an early UL grant from the target network node 16b), and thus cannot be discarded if needed.

In one example embodiment of the evaluation at the target network node 16b, the target network node 16b considers the congestion status of its radio resources. If there are many wireless devices 22 to be served, then it is unlikely that the incoming PDCP SDUs are to be transmitted shortly. Additionally, it might take some time for the target network node 16b to successfully transmit the SDUs to the wireless device 22, with for example HARQ/RLC retransmission. In other words, the target network node 16b takes into account the expected time to start to transmit this PDCP SDU and the expected time of a successful transmission of this PDCP SDU.

In another implementation example of the evaluation at the target network node 16b, when the data PDUs (e.g., PDCP SDUs) are associated, e.g., by application data units (ADUs), the source RAN (source network node 16a) may compute or send the reference time and this information to the target network node 16b. The target network node 16b can decide to discard PDCP SDUs with this information. In one example embodiment, if one important data PDU (e.g., I-frames in videos) is discarded by the target network node 16b due to it not being possible to deliver it on time, then the target network node 16b would also discard other data PDUs (e.g., B-frames and/or P-frames). In yet another example, if the target network node 16b faces a choice of only being able to deliver one out of three frames, it would choose the I-frame instead of the B-frame or P-frame).

In some embodiments, after evaluation, the target network node 16b may need to discard all PDCP SDUs that would be forwarded from the source network node 16a. This means that it would make little sense to receive the downlink data, the target network node 16b could determine to reject the downlink data forwarding tunnel from the source network node 16a.

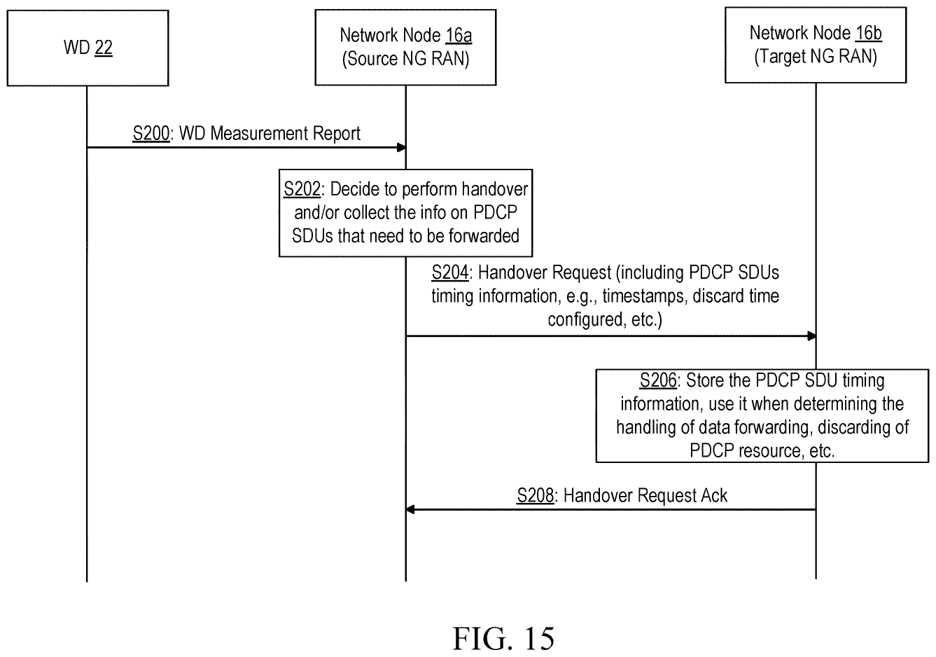

The sequence of the above embodiments is illustrated in the FIG. 15, which depicts an example flow chart and signaling diagram for DL data discard in some embodiments of the present disclosure. In step S200, the wireless device 22 transmits a measurement report to the source network node 16a (serving NG-RAN). In step S202, the source network node 16a determines to perform handover, collecting the information on PDCP SDUs that need to be forwarded. In step S204, the source network node 16a transmits a handover request (including, PDCP SDUs timing information, such as timestamps, discard time configured, etc.) to the target network node 16b (Target NG-RAN). In step S206, the target network node 16b stores the PDCP SDU timing information, using it when determining the handling of data forwarding, discarding PDCP resource (e.g., PDCP SDU, PDCP PDU, etc.). In step S208, the target network node 16b (target NG-RAN) transmits a handover request acknowledgment to the source network node 16a (serving NG-RAN).

A similar approach could apply for QoS flow offloading, when the services need to be offloaded to another network node 16, e.g., another gNB-DU.

For signaling between the network nodes 16, in embodiments of the present disclosure, the signaling may be implemented over a control plane (e.g., XnAP, F1AP) and/or a user plane.

An example of a control plane solution is shown in the example Table 2 below, which is an example of introducing PDCP PDU time information in the Data Forwarding and Offloading Info from source NG-RAN node IE within the Handover Request message.

TABLE 2
Example of introducing PDCP SDU time information in the Data Forwarding and Offloading Info
from source NG-RAN node Information Element (IE) within the Handover Request message

| | | | IE type and | Semantics | | Assigned |
|---|---|---|---|---|---|---|
| IE/Group Name | Presence | Range | reference | description | Criticality | Criticality |
| QoS Flows To Be | | 1 | | | — | |
| Forwarded List | | | | | | |
| >QoS Flows To | | 1 | | | — | |
| Be Forwarded | | . . . <maxnoofQoSFlows> | | | | |
| Item | | | | | | |
| >>QoS Flow | M | | 9.2.3.10 | | — | |
| Identifier | | | | | | |
| >>DL | M | | 9.2.3.34 | | — | |
| Forwarding | | | | | | |
| >>UL | M | | 9.2.3.90 | This IE | — | |
| Forwarding | | | | shall be | | |
| | | | | ignored. | | |
| >>UL | O | | 9.2.3.95 | | YES | ignore |
| Forwarding | | | | | | |
| Proposal | | | | | | |
| >>Source DL | O | | Transport | | YES | ignore |
| Forwarding IP | | | Layer | | | |
| Address | | | Address | | | |
| | | | 9.2.3.29 | | | |
| >>Source Node | O | | Transport | | YES | ignore |
| DL Forwarding | | | Layer | | | |
| IP Address | | | Address | | | |
| | | | 9.2.3.29 | | | |
| Source DRB to | O | | DRB to | | — | |
| QoS Flow | | | QoS Flow | | | |
| Mapping List | | | Mapping | | | |
| | | | List | | | |
| | | | 9.2.1.15 | | | |
| PDCP PDU time | | | New | | YES | ignore |
| information | | | 9.2.x.y | | | |

An example embodiment of PDCP SDU timer information is shown in Table 3, below:

TABLE 3
Example of PDCP SDU timer information

| | | | IE type and | |
|---|---|---|---|---|
| IE/Group Name | Presence | Range | reference | Semantics description |
| DRBs Subject | | 1 . . . | | |
| for data | | <maxnoofDRBs> | | |
| forwarding | | | | |
| >DRB ID | M | | 9.2.3.33 | |
| >PDCP PDU list | M | 1 . . . | | |
| | | <maxnoofPDCPPDUs> | | |
| >>>PDCP | M | | PDCP SN | |
| PDU SN | | | | |
| >>>PDCP | M | | | The time Stamp for the PDCP |
| PDU Time | | | | PDU for which the target node |
| Stamp | | | | may need to discard the PDCP |
| | | | | PDU |
| >PDCP discard | O | | | The suggested configured |
| timer | | | | PDCP timer at the target NG- |
| | | | | RAN node |

In some embodiments, the “PDCP SDU time” related information can be included in other messages, such as in the “DRBs Subject To Status Transfer List” IE within the “SN STATUS TRANSFER” message. If included in the Handover Request message, the target NG-RAN node (network node 16b) could be based on the timer information, to determine if the data forwarding tunnel needs to be set up or not. It may be beneficial, in some cases, to ensure that the target NG-RAN node (network node 16b) only processes the fresh downlink data.

An example of user plane solution is depicted in Table 4, below:

TABLE 4
List of PDCP PDUs in the User plane indicates
timer information, such as time stamps, etc.

| | | | | | | | | Number |
|---|---|---|---|---|---|---|---|---|
| Bits | | | | | | | | of |
| 7 | 6 | 5 | 4 | 3 | 2 | 1 | 0 | Octets |

| PDU Type (=0) | | | Spare | DL | DL | Report | 1 |
|---|---|---|---|---|---|---|---|
| | | | | Discard | Flush | polling | |
| | | | | Blocks | | | |
| Spare | PDCP | Request | Report | User data | Assist. | Retransmission | 1 |
| | PDU | OutofSeq | Delivered | existence | Info. | flag | |
| | Timer | Report | | flag | Report | | |
| | Info | | | | Polling | | |
| | Presented | | | | Flag | | |
| | Flag | | | | | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| PDCP PDU included in the reporting List | 0 or 1 |
| PDCP PDU SN | 0 or 3 |
| PDCP PDU Time Information | 0 or 1 |
| Padding | 0-3 |

### Uplink Data Discard

In some embodiments, the wireless device 22 receives an indication from the network up-to which PDCP sequence number (SN) the wireless device 22 may discard the PDCP SDU and PDCP PDUs. The sequence number can include the ones that the wireless device 22 has assigned and the PDCP PDUs have been submitted for transmission in the lower layers at the source network node 16a.

For example, in some embodiments, if the wireless device 22 has assigned a sequence number of X and receives an indication of discard the PDCP SDU up-to sequence number X+5, then the wireless device 22 may discard SDU with sequence number X and/or discard future arrived PDCP SDUs from the upper layer with SN assigned normally as X+1, X+2, X+3, X+4, X+5.

In one variant, the wireless device 22 may discard the PDCP SDU X and future arrived PDCP SDUs X+1 . . . X+5. But for the next arrived PDCP SDU, the wireless device 22 does not introduce any PDCP SN gap. In other words, no PDCP SN gap may be introduced with this discarding, i.e., PDCP PDUs following this discard shall have subsequent sequence numbers to the PDCP PDU before this discard.

In one example scenario, the embodiment assumes that the wireless device 22 is configured with discard timer per PDCP SDU which is running during handover. What the network node 16a and/or network node 16b indicates to the wireless device 22 is some additional information about SDU discard not covered by the PDCP discard timer.

In one example embodiment, the indication can be transmitted from the target network node 16b with a PDCP control PDU that contains, e.g., a PDCP status report. In this report, it indicates up to the above said SN, the network (i.e., the target network node 16b) has received the PDCP SDUs.

In one related embodiment, the source network node 16a includes information on what time to expect for the subsequent UL PDCP SDUs, for example:

$$SN = X at time t\_x$$

$$SN = X + 1 at time t\_x1$$

$$SN = X + 2 at time t\_x2$$

The information may be included in the handover request message from the source network node 16a to the target network node 16b. Based on the timing information, the target network node 16b decides which PDCP SDUs to be discarded. For example, if the current time at the target network node 16b is t_y and t_x<t_y<t_x1, then the target network node 16b indicates to the wireless device 22 to discard PDCP SDU with SN=X. The target network node 16b may also indicate the wireless device 22 to discard PDCP SDU with SN=X+1, due to that t_y is very close to t_x1 and so the target network node 16b cannot allocate enough resources for the wireless device 22 to deliver the PDCP SDU.

Based on the time the target network node 16b receiving the RRC RRCReconfigurationComplete message, the target network node 16b knows which PDCP SDUs can be discarded (i.e., not useful).

In one embodiment for the wireless device 22 implementation, the wireless device 22 does not pre-process PDCP SDUs to PDCP PDUs during handover, i.e., it waits until handover interruption time passes, e.g., based on the indications provided by the network (e.g., network node 16a and/or network node 16b), as explained above. By waiting for potential discard after the handover, the wireless device 22 may avoid a need to wastefully re-pre-process PDCP PDUs to avoid SN gaps due to discards.

In one example embodiment, a network node 16a (or network node 16b) implementation ensures that the RLC SDU/PDU is not submitted for transmission in the lower layers (to avoid that the data cannot be discarded). In one example, the network node 16a and/or network node 16b can avoid allocating UL grants for transmission until the PDCP status report is correctly received by the wireless device 22.

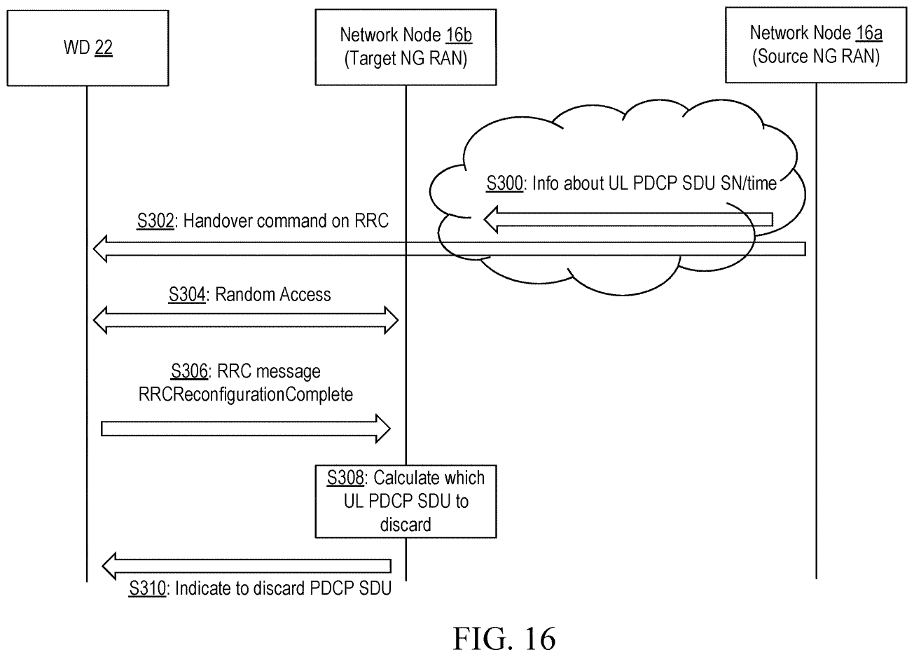

The sequence of the above embodiments is illustrated in FIG. 16, which depicts a flow chart and signaling diagram for UL data discarding according to some embodiments of the present disclosure. In step S300, the source network node 16a performs a handover by transmitting information about UL PDCP SDU SN/time to the target network node 16b. In step S302, the source network node 16a transmits a handover command on RRC to the wireless device 22. In step S304, the wireless device 22 performs a random access signaling (e.g., exchange of messages) with the target network node 16b. In step S306, the wireless device 22 transmits an RRC message RRCReconfigurationComplete to the target network node 16b. In step S308, the target network node 16b calculates which UL PDCP SDU to discard. In step S310, the target network node 16b indicates to the wireless device 22 to discard PDCP SDU.

In some example embodiments, the indication (i.e., indication up-to which PDCP sequence number (SN) the wireless device 22 shall discard the PDCP SDU and PDCP PDUs), is transmitted from the source network node 16a, e.g., included in the RRCReconfiguration message that includes the handover command or a PDCP status report before the handover command. The source network node 16a can consider the expected handover latency from the source network node 16a to the target network node 16b when indicating which SN to discard.

The expected handover latency can be estimated beforehand, e.g., by network node 16a, network node 16b, etc. In some embodiments, the indication (i.e., indication up-to which PDCP sequence number (SN) the wireless device 22 shall discard the PDCP SDU and PDCP PDUs) can be included in an RRC message transmitted from the target network node 16b after wireless device 22 has transmitted the RRCConfigurationComplete message to the target network node 16b.

The following is a nonlimiting list of example embodiments.

Embodiment A1. A target network node configured to communicate with a wireless device (WD) and a source network node, the target network node configured to, and/or comprising a radio interface and/or comprising processing circuitry configured to:
receive, from the source network node, a handover request including Packet Data Convergence Protocol, PDCP, timing information associated with at least one PDCP packet;
receive, from the source network node, the at least one PDCP packet;
determine at least one action for the PDCP packet based on the PDCP timing information; and
optionally, transmit, to the source network node, a handover request acknowledgment responsive to the received handover request.

Embodiment A2. The target network node of Embodiment A1, wherein the PDCP timing information includes at least one of:
a first time at which the PDCP packet became available for transmission in the source network node;
a second time at which a discard timer for the PDCP packet expires; and/or
a third time at which an Active Queue Management (AQM) mechanism triggers a drop for the PDCP packet.

Embodiment A3. The target network node of Embodiment A2, wherein the at least one action for the PDCP packet includes one of:
forwarding the PDCP packet to the wireless device; and
discarding the PDCP packet.

Embodiment A4. The target network node of Embodiment A3, wherein the discarding of the PDCP packet is based on the discard timer for the PDCP packet expiring.

Embodiment A5. The target network node of any one of Embodiments A3 and A4, wherein the discarding of the PDCP packet includes:
determining an importance metric associated with the PDCP packet; and
discarding at least one additional PDCP packet based on the importance metric exceeding a threshold.

Embodiment A6. The target network node of any one of Embodiments A1-A5, wherein the determining at least one action for the PDCP packet is further based on at least one of:
a fourth time at which the target network node is expected to begin transmitting the PDCP packet; and
a fifth time at which the target network node is expected to finish transmitting the PDCP packet.

Embodiment B1. A method implemented in a target network node, the method comprising:
receiving, from the source network node, a handover request including Packet Data Convergence Protocol, PDCP, timing information associated with at least one PDCP packet;
receiving, from the source network node, the at least one PDCP packet;
determining at least one action for the PDCP packet based on the PDCP timing information; and
optionally, transmitting, to the source network node, a handover request acknowledgment responsive to the received handover request.

Embodiment B2. The method of Embodiment B1, wherein the PDCP timing information includes at least one of:
a first time at which the PDCP packet became available for transmission in the source network node;
a second time at which a discard timer for the PDCP packet expires; and/or
a third time at which an Active Queue Management (AQM) mechanism triggers a drop for the PDCP packet.

Embodiment B3. The method of Embodiment B2, wherein the at least one action for the PDCP packet includes one of:
forwarding the PDCP packet to the wireless device; and
discarding the PDCP packet.

Embodiment B4. The method of Embodiment B3, wherein the discarding of the PDCP packet is based on the discard timer for the PDCP packet expiring.

Embodiment B5. The method of any one of Embodiments B3 and B4, wherein the discarding of the PDCP packet includes:
determining an importance metric associated with the PDCP packet; and
discarding at least one additional PDCP packet based on the importance metric exceeding a threshold.

Embodiment B6. The method of any one of Embodiments B1-B5, wherein the determining at least one action for the PDCP packet is further based on at least one of:
a fourth time at which the target network node is expected to begin transmitting the PDCP packet; and
a fifth time at which the target network node is expected to finish transmitting the PDCP packet.

Embodiment C1. A wireless device (WD) configured to communicate with a source network node and a target network node, the WD configured to, and/or comprising a radio interface and/or processing circuitry configured to:
perform a handover procedure from the source network node to the target network node, the target network node being configured by the source network node with PDCP timing information;
receive, from the target network node, an indication to discard at least one PDCP packet based on the PDCP timing information; and
optionally, discard the at least one PDCP packet based on the indication.

Embodiment C2. The WD of Embodiment C1, wherein the indication to discard the at least one PDCP packet includes an indicated sequence number, SN; and
the discarding of the at least one PDCP packet including:
   discarding a first PDCP packet; and
   discarding at least one subsequent PDCP packet based on the indicated SN being greater than or equal to a subsequent SN of the at least one subsequent PDCP packet.

Embodiment C3. The WD of Embodiment C2, wherein the WD is further configured to assign a new SN to at least one non-dropped PDCP packet following the at least one subsequent PDCP packet, the new SN being consecutive with a previous SN of a previous PDCP packet which was received prior to the first PDCP packet.

Embodiment D1. A method implemented in a wireless device (WD), the method comprising:
performing a handover procedure from the source network node to the target network node, the target network node being configured by the source network node with PDCP timing information;
receiving, from the target network node, an indication to discard at least one PDCP packet based on the PDCP timing information; and
optionally, discarding the at least one PDCP packet based on the indication.

Embodiment D2. The method of Embodiment D1, wherein the indication to discard the at least one PDCP packet includes an indicated sequence number, SN; and
the discarding of the at least one PDCP packet including:
   discarding a first PDCP packet; and
   discarding at least one subsequent PDCP packet based on the indicated SN being greater than or equal to a subsequent SN of the at least one subsequent PDCP packet.

Embodiment D3. The method of Embodiment D2, further comprising assigning a new SN to at least one non-dropped PDCP packet following the at least one subsequent PDCP packet, the new SN being consecutive with a previous SN of a previous PDCP packet which was received prior to the first PDCP packet.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| xR | eXtended Reality |
| VR | Virtual Reality |
| AR | Augmented Reality |
| MR | Mixed Reality |
| TTI | Transmission Time Interval |
| Fps | Frames Per Second |
| PDU | Protocol Data Unit |
| QFI | QoS Flow ID |
| QoS | Quality of Service |
| SMF | Session Management Function |
| PDR | Packet Detection Rules |
| PDU | Protocol Data Unit |
| SDU | Service Data Unit |
| PDCP | Packet Data Convergence Protocol |
| RLC | Radio Link Control |

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A source network node at configured to communicate with a wireless device, WD, and a target network node, the source network node being configured to:
obtain timing information associated with a Packet Data Convergence Protocol, PDCP, resource, the PDCP resource corresponding to a packet scheduled for downlink transmission from the source network node at or uplink transmission from the WD; and
transmit the timing information associated with the PDCP resource to the target network node for the target network node to determine, after a handover request has been transmitted by the source network node, whether to discard or cause the WD to discard the PDCP resource or the packet based on the timing information.

2.-10. (canceled)

11. A method in a source network node configured to communicate with a wireless device, WD, and a target network node, the method comprising:
obtaining timing information associated with a Packet Data Convergence Protocol, PDCP, resource, the PDCP resource corresponding to a packet scheduled for downlink transmission from the source network node or uplink transmission from the WD; and
transmitting the timing information associated with the PDCP resource to the target network node for the target network node to determine, after a handover request has been transmitted by the source network node, whether to discard or cause the WD to discard the PDCP resource or the packet based on the timing information.

12. The method of claim 11, wherein the timing information associated with the PDCP resource includes one or more of:
when the PDCP resource became available for transmission at the source network node;
when a discard timer for the PDCP resource times out;
when an active queue management, AQM, process triggers a drop for the PDCP resource;
when the source network node expects a subsequent uplink PDCCP resource;
PDCP protocol data unit, PDU, time information in data forwarding and offloading information associated with an information element within the handover request;
a PDCP PDU time stamp;
a PDCP discard timer; and
the PDCP PDU time information included in a reporting list.

13. The method of claim 11, wherein the method further includes:
determining whether to perform a handover of the WD from the source network node to the target network node based on a measurement report.

14.-16. (canceled)

17. The method of claim 11, wherein the method further includes:
determining that a timing condition cannot be met if the source network node or the WD transmits the PDCP resource or the packet, the timing condition being associated with the timing information.

18. (canceled)

19. The method of claim 11, wherein the PDCP resource is one or both of a PDCP PDU and a PDCP service data unit, SDU.

20. (canceled)

21. A target network node configured to communicate with a wireless device, WD, and a source network node, the target network node being configured to:
receive, from the source network node, timing information associated with a Packet Data Convergence Protocol, PDCP, resource, the PDCP resource corresponding to a packet scheduled for downlink transmission from the source network node or uplink transmission from the WD;
determine, after a handover request has been transmitted by the source network node, whether to discard or cause the WD to discard the PDCP resource or the packet based on the timing information; and
one of discard or cause the WD to discard the PDCP resource or the packet based on the determination.

22.-30. (canceled)

31. A method in a target network node configured to communicate with a wireless device, WD, and a source network node, the method comprising:
receiving, from the source network node, timing information associated with a Packet Data Convergence Protocol, PDCP, resource, the PDCP resource corresponding to a packet scheduled for downlink transmission from the source network node or uplink transmission from the WD;
determining, after a handover request has been transmitted by the source network node, whether to discard or cause the WD to discard the PDCP resource or the packet based on the timing information; and
one of discarding or causing the WD to discard the PDCP resource or the packet based on the determination.

32. The method of claim 31, wherein the timing information associated with the PDCP resource includes one or more of:
when the PDCP resource became available for transmission at the source network node;
when a discard timer for the PDCP resource times out;
when an active queue management, AQM, process triggers a drop for the PDCP resource;
when the source network node expects a subsequent uplink PDCCP resource;
PDCP protocol data unit, PDU, time information in data forwarding and offloading information associated with an information element within the handover request;
a PDCP PDU time stamp;
a PDCP discard timer; and
the PDCP PDU time information included in a reporting list.

33. (canceled)

34. The method of claim 31, wherein the method further includes:
receiving the handover request from the source network node, and wherein the timing information is included in the handover request.

35. (canceled)

36. The method of am claim 31, wherein the method further includes:
determining that a timing condition cannot be met if the target network node or the WD transmits the PDCP resource or the packet, the timing condition being associated with the timing information.

37. The method of claim 36, wherein the method further includes:
determining whether to discard or cause the WD to discard the PDCP resource or the packet further based on the determination that the timing condition cannot be met.

38. The method of claim 31, wherein causing the WD to discard includes:
transmitting an indication to the WD to discard the PDCP resource or the packet.

39. The method of claim 31, wherein the PDCP resource is one or both of a PDCP PDU and a PDCP service data unit, SDU.

40. (canceled)

41. A wireless device, WD, configured to communicate with a source network node and a target network node, the WD being configured to:
perform a handover of the WD from the source network node to the target network node, the target network node having received, from the source network node, timing information associated with a Packet Data Convergence Protocol, PDCP, resource, the PDCP resource corresponding to a packet scheduled for downlink transmission from the source network node or uplink transmission from the WD;
receive, from the target network node, an indication to discard the PDCP resource or the packet, the indication being transmitted based on the timing information; and
discard the PDCP resource or the packet based on the indication.

42.-47. (canceled)

48. A method in a wireless device, WD, configured to communicate with a source network node and a target network node, the method comprising:
performing a handover of the WD from the source network node to the target network node, the target network node having received, from the source network node, timing information associated with a Packet Data Convergence Protocol, PDCP, resource, the PDCP resource corresponding to a packet scheduled for downlink transmission from the source network node or uplink transmission from the WD;
receiving, from the target network node, an indication to discard the PDCP resource or the packet, the indication being transmitted based on the timing information; and
discarding the PDCP resource or the packet based on the indication.

49. The method of claim 48, wherein the indication includes a sequence number, SN, the method further including:
discarding the PDCP resource or the packet based on the SN.

50. The method of claim 49, wherein discarding the PDCP resource based on the SN includes:
discarding other PDCP resources up to the SN.

51. The method of claim 48, wherein the method further includes:
stopping preprocessing of PDCP resources during the handover based on the indication.

52. The method of claim 48, wherein the method further includes:
transmitting a first message indicating that a Radio Resource Control, RRC, configuration is complete; and
in response to the first message, receiving, from the target network node, a second message, the second message being an RRC message and including the indication.

53. The method of claim 48, wherein the PDCP resource is one or both of a PDCP PDU and a PDCP service data unit, SDU.

54. The method of claim 48, wherein the packet comprises DL data or UL data.
